(19) United States
(12) Patent Application Publication
(10) Pub. No.: US 2011/0083028 A1
(43) Pub. Date: Apr. 7, 2011

(54) APPARATUS FOR MINIMIZING STANDBY POWER OF SWITCHING-MODE POWER SUPPLY

(76) Inventor: Hun Jung, Seoul (KR)

(21) Appl. No.: 12/994,392

(22) PCT Filed: Jun. 4, 2009
(86) PCT No.: PCT/KR2009/002990

§ 371 Date: Nov. 23, 2010

(30) Foreign Application Priority Data
Jun. 4, 2008 (KR) 10-2008-0052511

(51) Int. Cl. G06F 1/32

(52) U.S. Cl. 713/323; 713/340

(57) ABSTRACT

The present invention relates to an apparatus for minimizing the standby power of a Switching Mode Power Supply (SMPS). The apparatus for minimizing standby power according to the present invention is connected between an Alternating

Current (AC) power source unit and the SMPS, and is configured to switch power supplied from the AC power source unit to the SMPS and receive a feedback of power supplied from the SMPS to an LED illumination apparatus. Accordingly, the present invention provides the advantage of minimizing the power consumption of an SMPS and the advantage of offering notifications about the status of the supply of power in real time and therefore enabling the efficient management of the supply of power.

### TECHNICAL FIELD

The present invention relates to an apparatus for minimizing the standby power of a switching mode power supply, and, more particularly, to an apparatus for minimizing the standby power of an SMPS, which is used in a Light-Emitting Diode (LED) illumination apparatus.

### BACKGROUND ART

In general, information and household electronic appliances widely use switching mode power supplies (hereinafter referred to as “SMPSs”) having higher efficiency and smaller capacity than non-switching power supplies as power supplies. An SMPS remains in a state of operating and supplying power even in standby mode in which household electronic appliances do not perform their intrinsic functionality, with the result that it consumes a considerable amount of power even when in standby mode.

The functionality of a conventional SMPS is carried out by controlling the gate signals of a MOSFET functioning as a switch by using a PWM signal generator. A conventional technology for reducing standby power as described above uses a technique of reducing the amount of power consumption by reducing the number of times that switching is performed using a method of preventing feedback signals, that is, signals transferred from a load, or PWM signals depending on variations in the source current of a MOSFET from being generated at periods longer than those of the existing pulse width adjustment.

However, although this method uses a technique of reducing the amount of power consumption by reducing the number of times that PWM signals, that is, MOSFET gate signals, are switched when power consumption is low in a load stage, this reduces the amount of power consumption compared to normal operation, but the SMPS is continuously operated because switching is still performed at regular intervals, so that a certain amount of power is being continuously consumed.

Furthermore, in order to reduce the standby power of a large-capacity SMPS, a variety of different methods, such as a method of additionally using a small-capacity auxiliary SMPS, have been attempted.

In particular, when an SMPS is applied to a large-capacity LED illumination apparatus, there is an increased need to reduce standby power.

FIG. 1 is a diagram illustrating the configuration of a typical SMPS which drives an LED illumination apparatus.

Referring to FIG. 1, the SMPS includes an AC power source unit 10 for supplying AC voltage, an SMPS 30 for rectifying and switching the AC voltage supplied by the AC power source unit 10 and then supplying power, an LED illumination apparatus 40 for emitting light using the power supplied by the SMPS 30, and a central control server 60 for controlling the LED illumination apparatus 40.

Here, the SMPS 30 includes an AC-DC rectification circuit 32, a switching unit 33, a transformer 34, a DC-DC rectification circuit 35, and a control unit 36, and supplies the output DC power to the LED illumination apparatus 40.

The AC-DC rectification circuit 32 converts AC voltage, obtained by filtering out noise from the AC voltage supplied by the AC power source unit, into Direct Current (DC) voltage, and outputs the DC voltage to the switching unit 33.

The switching unit 33 performs switching at frequencies of several tens of Khz˜several Mhz using a device, such as a high-withstanding voltage TR, a MOSFET or an IGBT, and performs output to the transformer 34.

The transformer 34 performs its functionality depending on the magnitude of usable frequency and working power, and performs output to the DC-DC rectification circuit 35.

The DC-DC rectification circuit 35 converts the resulting DC power to power suitable for the LED illumination apparatus 40 in response to a switching control signal input to the control unit 36, and supplies the power to the LED illumination apparatus 40.

In this case, in standby mode in which it is not necessary to supply power to the LED illumination apparatus 40, the output of the unnecessary parts of the DC-DC rectification circuit 35 and the secondary coil side (not shown) of the transformer 34 is interrupted or reduced under the switching control of the control unit 36, thereby interrupting or reducing the supply of power to parts which do not require power to be supplied to them when in standby mode.

However, in the standby mode of this case, power is continuously supplied to the SMPS and power is continuously consumed by the control unit 36 and the DC-DC rectification circuit 35, so that there is the problem of a considerable amount of standby power still being consumed.

### DISCLOSURE

### Technical Problem

Accordingly, the present invention has been made keeping in mind the above problems occurring in the prior art, and an object of the present invention is to provide an apparatus for minimizing the standby power of an SMPS which interrupts the provision of standby power and enables power to be provided only by the power of a battery unit by controlling an SMPS for LED illumination, thereby minimizing standby power.

### Technical Solution

In order to accomplish the above object, the present invention provides an apparatus for minimizing standby power, the apparatus for minimizing standby power being connected to an Alternative Current (AC) power source unit for supplying AC voltage, a Switching Mode Power Supply (SMPS) for supplying power by rectifying and switching the AC voltage supplied by the AC power source unit, a Light-Emitting Diode (LED) illumination apparatus for emitting light using the power supplied by the SMPS, and a central control server for controlling the LED illumination apparatus, wherein the apparatus for minimizing standby power is connected between the AC power source unit and SMPS, and is configured to switch power supplied from the AC power source unit to the SMPS and to receive a feedback of power supplied from the SMPS to the LED illumination apparatus, including a power control unit for selectively allowing and interrupting supply of power from the AC power source unit to the SMPS; a power monitoring unit for monitoring power input to and output from the SMPS; a battery unit for storing the feedback power as the standby power; a standby power control unit for controlling the power control unit in response to a power control command from the central control server so that the power control unit selectively supplies and interrupts the power, controlling charging of the battery unit in accordance with results of monitoring the power monitoring unit, and outputting an alarm signal and an alarm control signal if an abnormality occurs in the power input to the SMPS; an alarm unit for generating an alarm in response to the alarm signal; and a wired/wireless communication unit for transmitting the alarm control signal to the central control server.

Furthermore, the power control unit may perform fast switching and, therefore, may decrease an average value of a voltage by controlling an angular width of current of sine wave power input from the AC power source unit.

Furthermore, the battery unit may provide previously stored power to the above elements when the supply of power to the SMPS is interrupted.

Furthermore, the standby power control unit may control the above elements so that the power from the SMPS is used as standby power when the supply of power to the SMPS is allowed, and control the above elements so that the power of the battery unit is used as the standby power when the supply of power to the SMPS is interrupted.

### Advantageous Effects

Accordingly, the present invention provides the advantage of minimizing the power consumption of an SMPS and the advantage of offering notifications about the status of the supply of power in real time and therefore enabling the efficient management of the supply of power.

### DESCRIPTION OF DRAWINGS

FIG. 1 is a sectional view showing typical, essential components;

FIG. 2 is a diagram showing the configuration of an apparatus for minimizing standby power according to an embodiment of the present invention;

FIG. 4 is a graph showing the waveform of power input to the power control unit of FIG. 2;

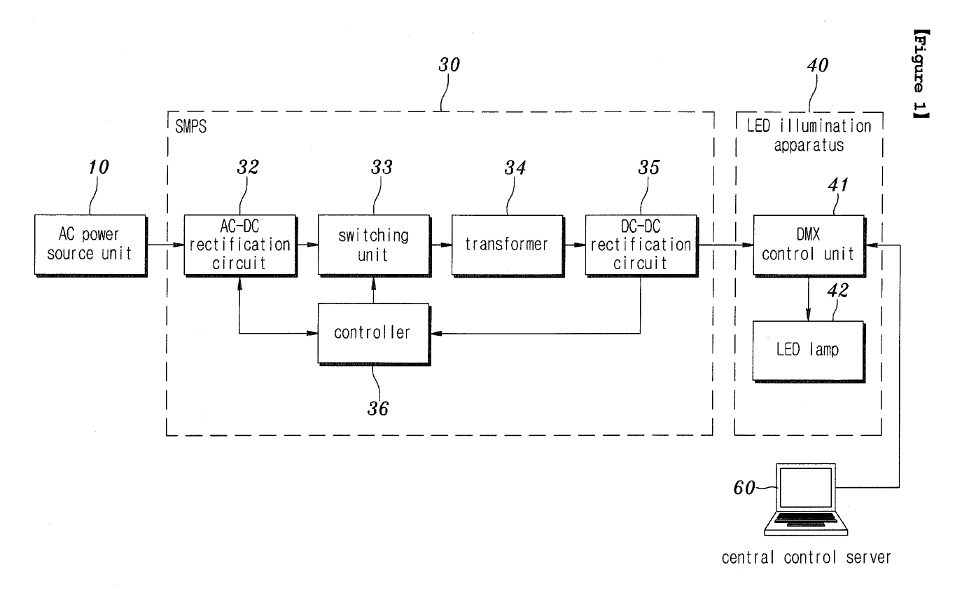

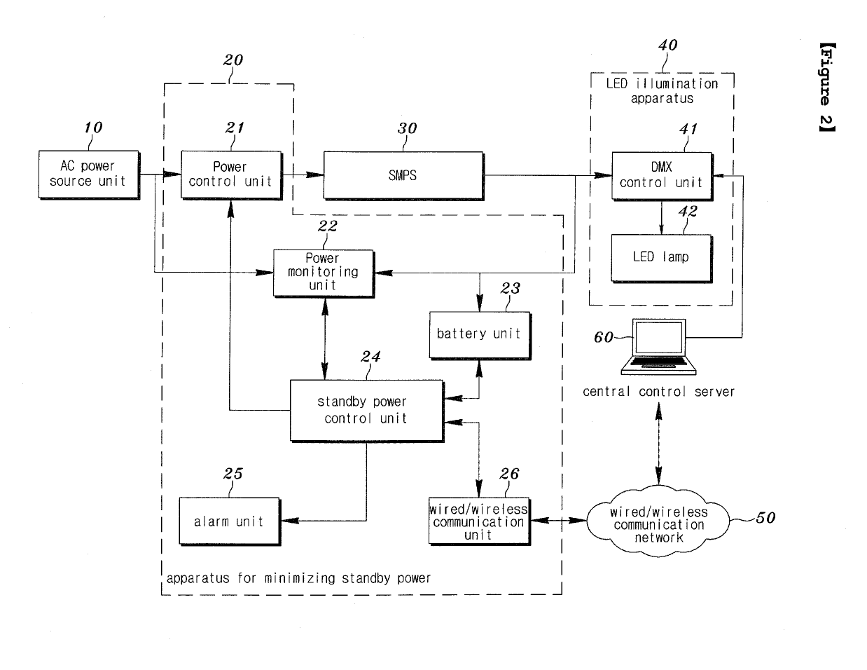

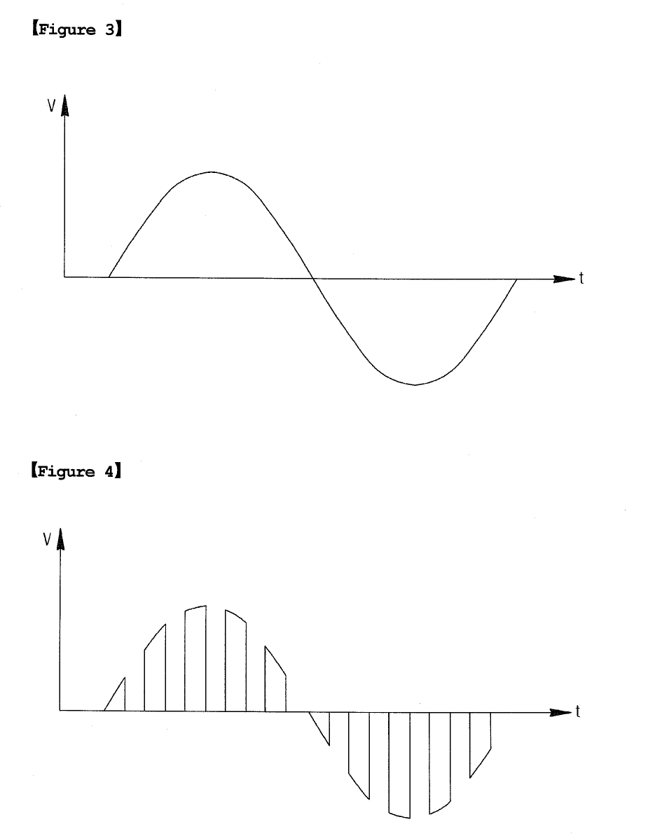

FIG. 3b is a graph showing the waveform of power output from the power control unit of FIG. 2; and

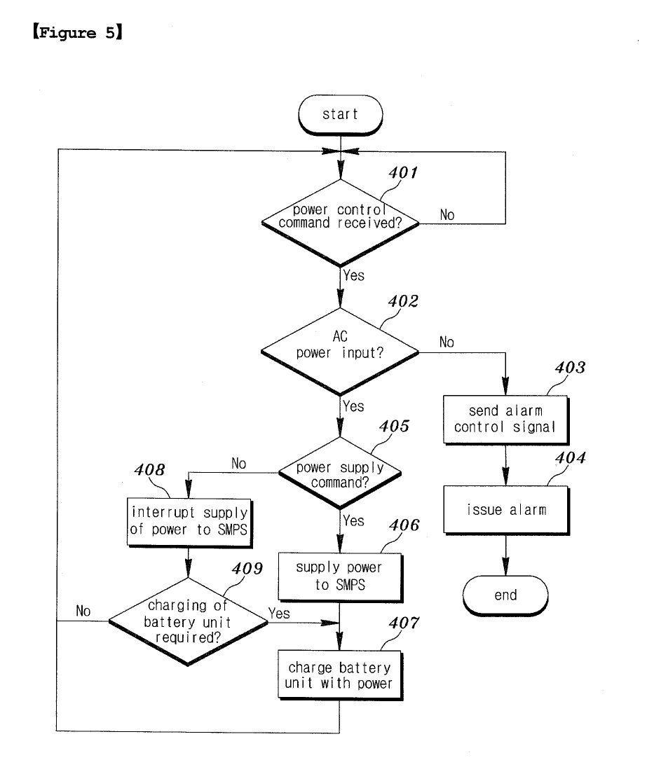

FIG. 4 is a diagram showing the control flow of the apparatus of FIG. 3.

### DESCRIPTION OF REFERENCE NUMERALS OF PRINCIPAL ELEMENTS IN THE DRAWINGS

20: apparatus for minimizing standby power

21: power control unit

22: power monitoring unit

23: battery unit

24: standby power control unit

25: alarm unit

26: wired/wireless communication unit

### MODE FOR INVENTION

Preferred embodiments of the present invention will be described in detail below with reference to FIGS. 2 to 4.

FIG. 2 is a diagram showing the configuration of an apparatus for minimizing standby power according to an embodiment of the present invention.

Referring to FIG. 2, the apparatus for minimizing standby power 20 is connected between an AC power source unit 10 and an SMPS 30, and is configured to selectively supply and interrupt power, supplied by the AC power source unit 10 to the SMPS 30, by switching the power. Furthermore, the apparatus for minimizing standby power 20 is connected to the central control server 60 over a wired/wireless communication network. Furthermore, the apparatus for minimizing standby power 20 is configured to receive the feedback of power, supplied by the LED illumination apparatus 40, from the SMPS 30.

The apparatus for minimizing standby power 20 includes a power control unit 21 for switching the supply of power from the AC power source unit 10, a power monitoring unit 22 for monitoring power input to and output from the SMPS 30, a battery unit 23 for charging standby power, a standby power control unit 24 for checking whether power is supplied to the SMPS 30 and performing control of the charging depending on the status of charging of the battery unit 23, an alarm unit 25 for providing notification of the results of monitoring the output power of the AC power source unit, and a wired/wireless communication unit 26 for transmitting power supply interruption status to the central control server 60.

The power control unit 21 selectively supplies or interrupts power, supplied by the external AC power source unit 10 to the SMPS 30, in response to power supply control signals from the standby power control unit 24 through the central control server 60. In particular, the power control unit 21 of the present invention can reduce the average value of the voltage flowing into the SMPS 30 by controlling the angular width of the current of sine wave power flowing from the external AC power source unit 10 using an Insulated Gate Bipolar Transistor (IGBT) or a triac which is capable of performing fast switching (at frequencies of several tens of Khz˜several Mhz).

Accordingly, the present invention is configured to adjust the voltage of power input to the SMPS 30 by adjusting the ON/OFF time of the switch while switching the power control unit 21 at high speed. Accordingly, the drive power level of the SMPS 30 is reduced, so that the power consumption of the SMPS 30 can be minimized and the size of the SMPS 30 can be also reduced.

An example in which the level of power that the power control unit 21 supplies while performing fast switching is decreased will now be described with reference to the graphs of FIGS. 4 and 3b.

FIG. 4 is a graph showing the waveform of power input from the external AC power source unit 10 to the power control unit 21, and FIG. 3b is a graph showing the waveform of power output from the power control unit 21 to the SMPS 30.

As shown in FIG. 45, the voltage values of a sine wave generated by power output from the external AC power source unit 10 are represented. It can be seen that after the power control unit 21 has received and switched the voltage values, the average voltage level of the power input to the SMPS 30 is considerably reduced, as shown in the graph of FIG. 5.

As described above, the power control unit 21 performs fast switching in response to power supply control signals from the standby power control unit 24, so that the level of the drive power is reduced and then input to the SMPS 30. At this time, the power monitoring unit 22 monitors whether power is supplied from the external AC power source unit 10 to the SMPS 30 and whether power is, in turn, supplied from the SMPS 30 to the LED illumination apparatus 40, and outputs results of the power monitoring to the standby power control unit 24. Here, the power monitoring unit 22 may be implemented in various ways. If there is a massive amount of power supplied to the power control unit 21, the power monitoring unit 22 may be configured in a non-contact way which is capable of monitoring whether power is supplied using variations in the magnetic field which is generated in a power line. The power which is used to control the power control unit 21 may be implemented by operating a photo coupler using the power obtained by collecting a magnetic field, generated in a power line, using a non-contact induction coil.

Meanwhile, the battery unit 23 receives part of the DC power which is output from the SMPS 30 to the LED illumination apparatus 40 when the power control unit 21 performs fast switching and supplies power to the SMPS 30, and then stores it therein. When the power control unit 21 goes to OFF and therefore the supply of power from the external AC power source unit 10 to the SMPS 30 is interrupted, the power stored in the battery unit 23 is supplied to the individual components of the standby power control unit 24 and the apparatus 20 for minimizing standby power.

The standby power control unit 24 receives a power control command from the central control server 60 through the wired/wireless communication unit 26, and analyzes the power control command. The standby power control unit 24 creates power control signals in accordance with the analyzed power control command, and selectively turns on and off the power control unit 21.

In this case, the standby power control unit 24 outputs a series of PWM control signals to the power control unit 21 so that the power control unit 21 implemented using an IGBT or a TRIAC performs a fast switching operation. Furthermore, the standby power control unit 24, in turn, receives the power output to the SMPS 30 and adjusted such that the average voltage thereof has been reduced, compares it with a preset average value, and adjusts the control signals output to the power control unit 21, thereby enabling power of voltage having the preset average value to be input to the SMPS 30.

Furthermore, the standby power control unit 24 controls the amount of power applied to the SMPS 30, thereby minimizing power consumption caused by the natural charging and discharging of a smoothing capacitance disposed in the initial stage of the SMPS 30.

Furthermore, the standby power control unit 24 causes power to be supplied from the SMPS 30 to the individual components of the apparatus 20 for minimizing standby power when the power control unit 21 is turned on and power is supplied from the external AC power source unit 10 to the SMPS 30, and issues an order to supply power from the battery unit to the individual components of the apparatus for minimizing standby power 20 when the power control unit 21 is turned off and the supply of power from the external AC power source unit 10 to the SMPS 30 is interrupted.

Furthermore, when the standby power control unit 24 receives a power supply command from the central control server 60, it performs control so that the SMPS 30 supplies DC power to the LED illumination apparatus 40.

Furthermore, the standby power control unit 24 detects the power level of the battery unit 23, and, if the power level is decreased to a level below a predetermined level, outputs a power supply control signal to the power control unit 21, turns on the power control unit 21, and charges the battery unit 23 with DC power output from the SMPS 30.

Furthermore, the standby power control unit 24 receives a power detection signal from the power monitoring unit 22, and monitors whether power is currently being supplied from the external AC power source unit 10 to the power control unit 21. If power is not being supplied, an alarm control signal is created, is output to the wired/wireless communication unit 26, and is sent to the central control server 60. At the same time, the alarm unit 25 is controlled, so that an alarm signal is output to notify an administrator that power is not currently being supplied from the external AC power source unit 10.

The wired/wireless communication unit 26 receives a power control command from the central control server 60 over the wired/wireless communication network 50, and outputs the power control command to the standby power control unit 24. Furthermore, the alarm control signal input from the standby power control unit 24 is sent to the central control server 60 over the wired/wireless communication network 50.

Here, when the alarm unit 25 receives a signal indicating the abnormality of the system from the standby power control unit 24, the alarm unit 25 may output a sound, such as a siren, using a sound output device which is implemented using a speaker or the like, and may indicate an alarm to the exterior by flickering an alarm light.

FIG. 4 is a diagram showing the control flow of the apparatus of FIG. 3.

Referring to FIG. 4, the standby power control unit 24 determines whether a power control command has been received from the central control server 60 at step 401. If, as a result of the determination, the power control command has been received, it is determined whether AC power is being normally input to the power monitoring unit 22 from the external AC power source unit 10 at step 402. If, as a result of the determination, it is determined that AC power is not being normally input from the external AC power source unit 10, an alarm control signal providing notification to the central control server 60 is sent using the wired/wireless communication unit 26 at step 403. Furthermore, the alarm signal is output to the alarm unit 25, so that an alarm is generated at step 404.

Meanwhile, if as a result of the determination, it is determined that AC power is being normally input from the external AC power source unit 10, it is determined whether the received power control command is a power supply command at step 405. If, as a result of the determination, the received power control command is a power supply command, the standby power control unit 24 creates a power supply control signal and outputs it to the power control unit 21, thereby supplying power to the SMPS 30 at step 406. In this case, part of DC power output from the SMPS 30 to the LED illumination apparatus 40 is fed back, and then power is not only supplied to the individual components of the apparatus for minimizing standby power 20 but is also stored in the battery unit at step 407.

Meanwhile, if, as a result of the determination at step 405, the received power control command is not a power supply command, the standby power control unit 24 outputs a power interruption control signal to the power control unit 21, thereby interrupting power to be supplied to the SMPS 30 at step 408. Furthermore, the standby power control unit 24 determines whether charging is required by continuously monitoring the charging status of the battery unit 23 at step 409 so that the individual components of the apparatus for minimizing standby power 20 can be continuously operated. If, as a result of the determination, it is determined that charging is required, control is performed such that the battery unit is charged. In contrast, if charging is not required, the process returns to step 401.

Meanwhile, although in the above-described preferred embodiment of the present invention, the standby power control unit 24 has been described as determining whether DC power is being supplied from the SMPS 30 if the level of the power stored in the battery unit 23 decreases to a level below a predetermined level, the standby power control unit 24 may be configured to monitor whether power is being supplied in real time regardless of the power level of the battery unit 23 and to, if the supply of power is interrupted, immediately create an alarm signal, send it to the central control server 60, and cause it to be output to the alarm unit 25.

So far the apparatus for minimizing standby power according to the preferred embodiment of the present invention has been described. As described above, the conventional technology is intended to minimize standby power by controlling the supply and interruption of power to be supplied from the SMPS 30 to a load while continuously supplying power to the SMPS 30, and the present invention is intended to minimize standby power by controlling power itself to be supplied to the SMPS 30.

In this case, the effect is achieved whereby the power consumed by the apparatus for minimizing power in standby mode becomes considerably less than that consumed by the SMPS 30 of the conventional technology when in standby mode.

In greater detail, in standby mode, a power in a range of several mA˜several tens of mA is consumed by the SMPS 30 of the conventional technology while a power of several A or less is consumed by the apparatus for minimizing power of the present invention, so that the power consumption becomes considerably less than that of the conventional technology.

When the power monitoring unit 22, which is the principal power consuming component of the apparatus for minimizing power, is operated by induced electromotive force based on variations in the magnetic field in a line along which is flowing power supplied by the external power source, hardly any power consumption takes place, so that the consumption of standby power is further considerably decreased.

So far the present invention has been described, with a focus on the preferred embodiments. Those skilled in the technology field to which the present invention pertains can grasp that the present invention can be implemented in a modified form within a range which does not deviate from the essential characteristics of the present invention. Accordingly, the disclosed embodiments should be interpreted not as being limitative but as being illustrative.

The scope of the present invention is set out not in the specification but in the claims, and it should be interpreted that all variations falling within a range equivalent to the claims are included in the present invention.

1. An apparatus for minimizing standby power, the apparatus for minimizing standby power being connected to an Alternative Current (AC) power source unit for supplying AC voltage, a Switching Mode Power Supply (SMPS) for supplying power by rectifying and switching the AC voltage supplied by the AC power source unit, a Light-Emitting Diode (LED) illumination apparatus for emitting light using the power supplied by the SMPS, and a central control server for controlling the LED illumination apparatus, wherein the apparatus for minimizing standby power is connected between the AC power source unit and SMPS, and is configured to switch power supplied from the AC power source unit to the SMPS and to receive a feedback of power supplied from the SMPS to the LED illumination apparatus,
comprising:
a power control unit for selectively allowing and interrupting supply of power from the AC power source unit to the SMPS;
a power monitoring unit for monitoring power input to and output from the SMPS;
a battery unit for storing the feedback power as the standby power;
a standby power control unit for controlling the power control unit in response to a power control command from the central control server so that the power control unit selectively supplies and interrupts the power, controlling charging of the battery unit in accordance with results of monitoring the power monitoring unit, and outputting an alarm signal and an alarm control signal if an abnormality occurs in the power input to the SMPS;
an alarm unit for generating an alarm in response to the alarm signal; and
a wired/wireless communication unit for transmitting the alarm control signal to the central control server.

2. The apparatus as set forth in claim 1, wherein the power control unit can perform fast switching and, therefore, can decrease an average value of a voltage by controlling an angular width of current of sine wave power input from the AC power source unit.

3. The apparatus as set forth in claim 1, wherein the battery unit provides previously stored power to the above elements when the supply of power to the SMPS is interrupted.

4. The apparatus as set forth in claim 1, wherein the standby power control unit controls the above elements so that the power from the SMPS is used as standby power when the supply of power to the SMPS is allowed, and controls the above elements so that the power of the battery unit is used as the standby power when the supply of power to the SMPS is interrupted.
